(19) United States
(12) Patent Application Publication
(10) Pub. No.: US 2003/0196090 A1
(43) Pub. Date: Oct. 16, 2003

(54) Digital signature system

(76) Inventor: Ryuji Nagahama, Tokyo (JP)

Correspondence Address: BIRCH STEWART KOLASCH & BIRCH, PO BOX 747, FALLS CHURCH, VA, 22040-0747, US

(21) Appl. No.: 10/379,598

(22) Filed: Mar. 6, 2003

(30) Foreign Application Priority Data
Apr. 12, 2002 (JP) 2002-110543

(51) Int. Cl. H04L 9/00

(52) U.S. Cl. 713/176; 713/156

(57) ABSTRACT

In the digital signature system, a server 1 is provided with a tamper resistant HSM 13 having stored therein a digital certificate 11, which is equivalent to an official seal, issued to an organization, a digital signature unit 17 for applying digital signature processing to digital data using the digital certificate 11, a person in charge database memory unit 22 having stored therein a database of a person in charge authorized to request digital signature, and a digital signature request reception unit 16 for receiving a request for digital signature sent from a terminal for person in charge together with the digital data 14 to be an object of digital signature and at the same time, judging whether or not the received request for digital signature is a request sent by a person in charge stored in the person in charge database memory unit 22.

### BACKGROUND OF THE INVENTION

1. Field of the Invention

The present invention relates to a digital signature system and, in particular, to a digital signature system for performing digital signature processing using a digital certificate, which is equivalent to an official seal, issued to an organization and shared by the organization.

2. Description of the Related Art

In recent years, the information-oriented society has achieved remarkable development, which has led to prevalence of paperless offices. Consequently, since important papers that have been prepared as a paper document having signed and sealed thereon in the past tend to be prepared in a digital form, a technique called a digital signature equivalent to significance of the conventional signature and seal is regarded as necessary. Further, the digital signature is data for authentication that is obtained by encrypting a document using a secret key in a digital certificate issued by a certification authority. According to the data for authentication, an authenticator verifies that a document has been signed by a principal and the document has not been falsified. A signer of a digital signature may be not only an “individual” but also an “organization”. For example, a signer is an “organization” in the case in which a digital signature is equivalent to an official seal such as a company seal or a seal of a representative director.

FIG. 7 shows a structure of a conventional digital signature system in the case in which a digital signature is applied to digital data using a digital certificate, which is equivalent to significance of putting an official seal, issued to an organization (rather than an individual). In the figure, reference numeral 101 denotes a certification authority and 102 denotes a digital certificate issued to an organization by the certification authority 101. The digital certificate 102 includes a secret key for performing digital signature processing and a public key certificate for certifying a public key that forms a pair with the secret key. Reference numeral 103 denotes an operation unit, which is used by an operator for operation in applying a digital signature to digital data (digitally structured document) using the digital certificate 102. The operation unit 103 is constituted by, for example, a keyboard or a mouse. Reference numeral 104 denotes digital data to be an object of digital signature and 105 denotes a digital signature processing unit, which is constituted by a computer such as a personal computer, for applying digital signature processing to the digital data 104 using the digital certificate 102. Note that, when there are a plurality of persons in charge of operation of the digital signature (operators), the operation unit 103, the digital data 104, and the digital signature processing unit 105 exist in a plural form corresponding to the number of the persons in charge.

Next, operations will be described. In order to utilize the digital certificate 102 issued to an organization from the certification authority 101 at the time of digital signature, as shown in FIG. 8, the digital certificate 102 is stored in a portable recording medium 106 such as an IC card to be borrowed from the organization and carried. Alternatively, the digital certificate 102 is copied in a memory device 107 such as a hard disk provided in an operator terminal such as a personal computer in advance to be utilized.

A person in charge operates the operation unit 103 to take out the digital certificate 102 from the recording medium 106 or the memory device 107. Next, the person in charge inputs an instruction for applying a digital signature to the digital data 104 to be an object of digital signature on the operator terminal. Consequently, the digital signature processing unit 105 in the operator terminal encrypts the digital data 104 with the secret key in the digital certificate 102, generates a digital signature and combines the digital signature and the original digital data to generate one file.

The conventional digital signature system is constituted as described above. In the conventional digital signature system, the digital certificate 102 issued to an organization is often stored in the portable recording medium 106 such as an IC card and carried to be utilized. Since a person who has obtained the recording medium 106 can carry it to anywhere, it becomes more likely that the digital certificate 102 is stolen or used illegally.

In addition, in the case in which the digital certificate 102 is copied in the memory device 107 such as a hard disk, the digital certificate 102 exists in individual operator terminals of persons in charge who utilize it. Therefore, it is difficult to strictly control the use of the digital certificate 102, and there is a possibility that a theft or illegal use increases.

Further, since digital signature processing is operated in the individual operator terminals of the persons in charge in the case in which the digital certificate 102 is stored either in the recording medium 106 or in the memory device 107, it is difficult to unitarily manage digital data with a digital signature or an execution record of digital signature. Therefore, even if a digital signature is applied to digital data using a digital certificate issued to an organization, it is difficult to prove that the certificate has not been stolen nor used illegally. In addition, the digital data with the digital signature cannot be managed in the organization. Due to such reasons, it cannot be guaranteed that the digital data is digital data to which a digital signature has been actually applied in the capacity of the organization.

### SUMMARY OF THE INVENTION

The present invention has been devised to solve the above-mentioned problems, and it is an object of the present invention to provide a digital signature system that is capable of preventing a theft or illegal use of a digital certificate issued to an organization and guaranteeing that digital data is one to which a digital signature has been applied in the capacity of the organization.

According to the present invention, a digital signature system comprises: at least one terminal device for operation by users connected to a communication network; and a server connected to the communication network, wherein the server comprises: digital certificate storing means for storing a digital certificate to be shared by the users; digital signature processing means for applying digital signature processing to digital data that is an object of digital signature using the digital certificate; user database storing means for storing a database of a user authorized to request a digital signature to the digital signature processing means; digital signature request reception means for receiving a request for digital signature that is sent from the terminal device together with the digital data that is an object of digital signature; and judging means for judging whether or not the received request for digital signature is one sent by the user stored in the user database storing means, and wherein the digital signature processing means performs the digital signature processing based on the request for digital signature that is judged to be appropriate by the judging means.

### BRIEF DESCRIPTION OF THE DRAWINGS

In the accompanying drawings:

FIG. 1 is an explanatory diagram showing a schematic structure of an entire digital signature system in accordance with a first embodiment of the present invention;

FIG. 2 is a block diagram showing a structure of the digital signature system in accordance with the first embodiment of the present invention;

FIG. 3 is an explanatory diagram showing a principle of digital signature processing in the digital signature system in accordance with the first embodiment of the present invention;

FIG. 4 is a flow chart showing a flow of processing at the time when a digital signature is requested in the digital signature system in accordance with the first embodiment of the present invention;

FIG. 5 is an explanatory diagram showing a flow of processing at the time when a digital signature is verified in the digital signature system in accordance with the first embodiment of the present invention;

FIG. 6 is a block diagram showing a structure of a server provided in a digital signature system in accordance with a second embodiment of the present invention;

FIG. 7 is a block diagram showing a structure of a conventional digital signature system; and

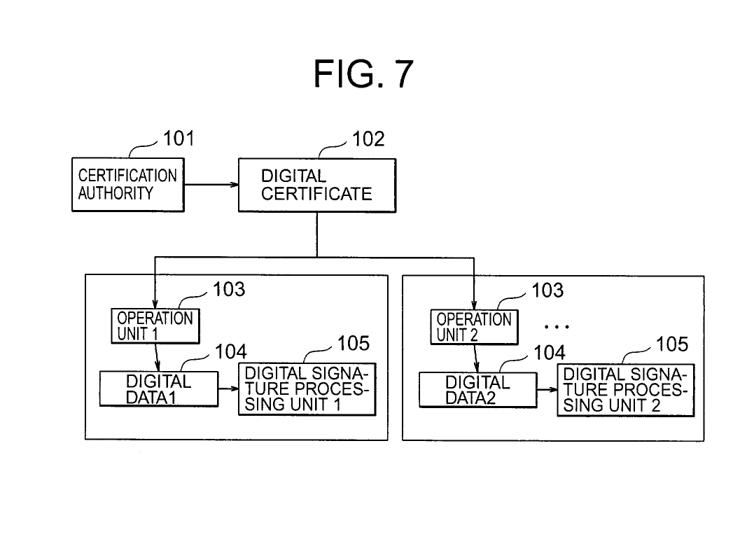

FIG. 8 is an explanatory diagram showing a method of keeping a digital certificate in the conventional digital signature system.

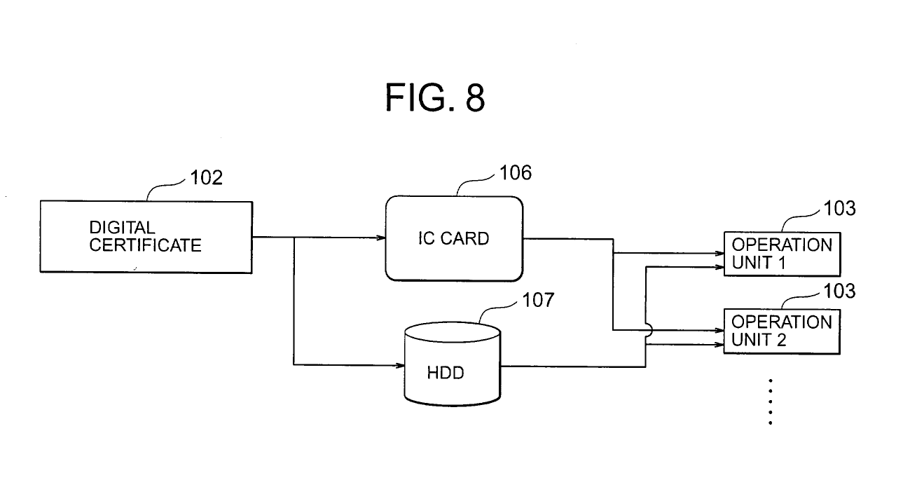

### DETAILED DESCRIPTION OF THE PREFERRED EMBODIMENTS

First Embodiment

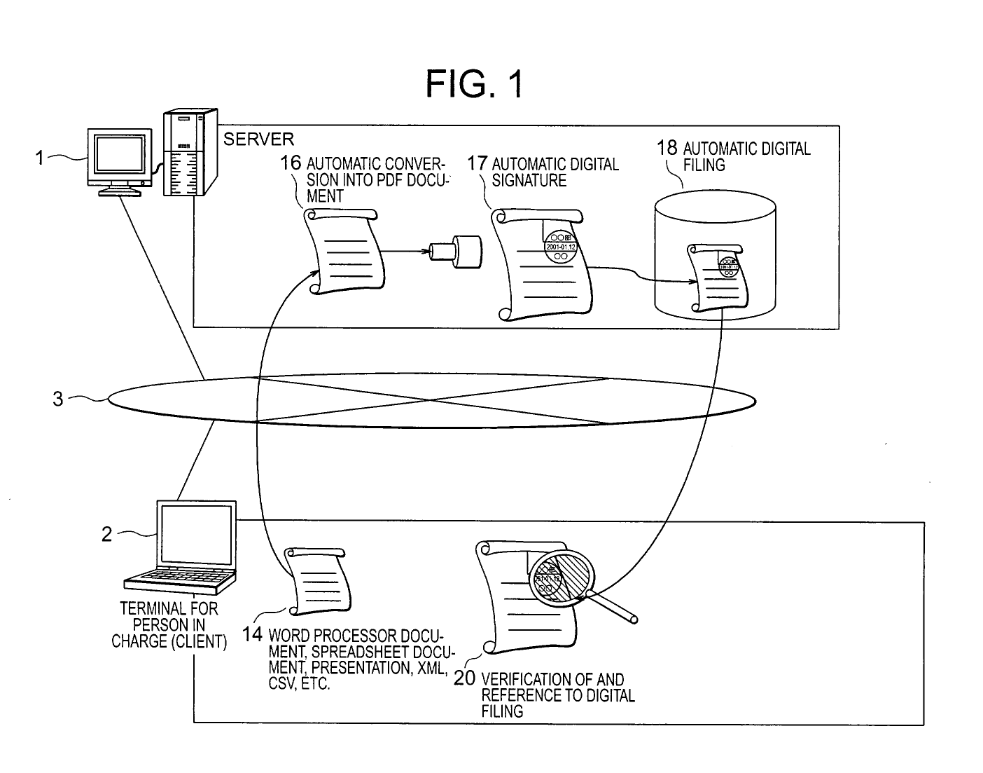

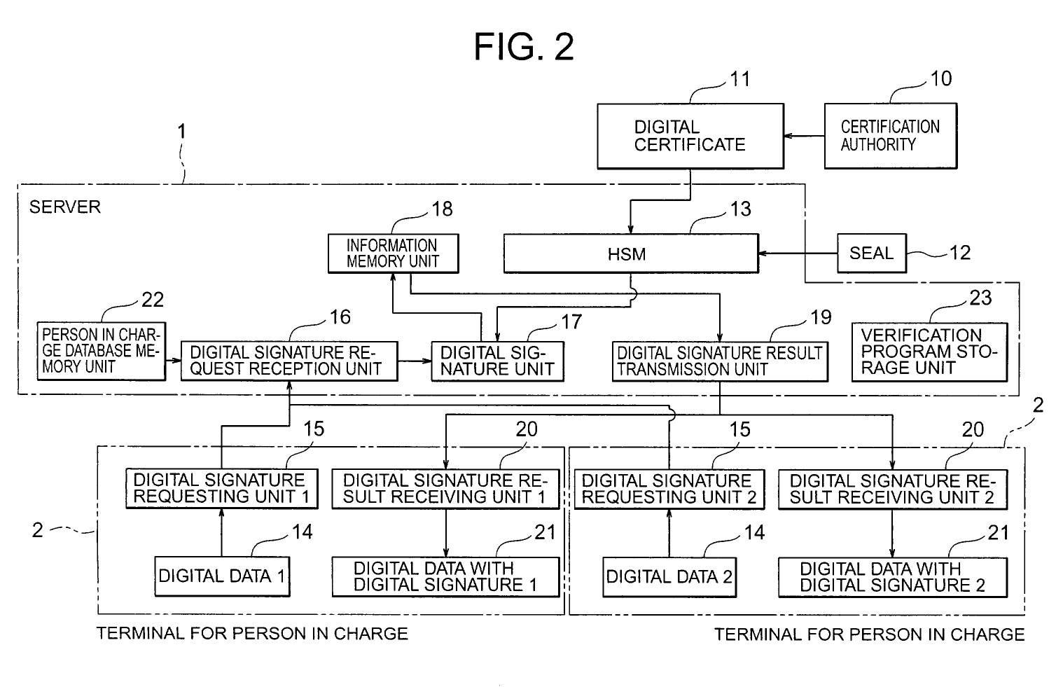

FIGS. 1 and 2 show a structure of a digital signature system in accordance with an embodiment of the present invention. In these figures, identical components are denoted by identical reference numerals. First, an entire schematic structure will be described with reference to FIG. 1. As shown in FIG. 1, the digital signature system of the present invention is constituted by a server 1 and a terminal for person in charge (client) 2. The server 1 and the terminal for person in charge 2 are connected by a communication network 3 such as the Internet or the Intranet. A flow of entire processing will be briefly described. Digital data (word processor document, spreadsheet document, presentation, CSV, XML or the like) 14 prepared in the terminal for person in charge 2 is sent to the server 1 via the communication network 3. In the server 1, the digital data is received and converted into a PDF document in a digital signature request reception unit 16. The server 1 performed the digital signature processing to the digital data converted to the PDF document using a digital certificate, which is equivalent to an official seal, issued to an organization (company, department, etc.) kept in the server 1 in a digital signature unit 17, and stored it in an information memory unit 18. Note that, since the digital certificate is equivalent to an official seal, it is shared by one or more persons in charge who are authorized to apply a digital signature. The terminal for person in charge 2 takes out the stored digital data with a digital signature via the communication network 3 to refer to contents of the digital data or verify the digital signature as needed.

Next, a specific structure of the digital signature system of the present invention will be described with reference to a block diagram of FIG. 2. In FIG. 2, reference numeral 10 denotes an certification authority that issues a digital certificate; 11, a digital certificate (including a secret key certificate and a public key certificate), which is equivalent to an official seal, issued from the certification authority 10; 12, a seal (also referred to as seal data or a digital seal) affixed to digital data when digital signature processing is performed; and 13, a hardware security module (hereinafter abbreviated as HSM) with tamper resistance for keeping the digital certificate 11 and the seal 12 while ensuring security, which is mounted in the server 1. Note that, the tamper resistance means having a structure that does not allow illegal internal analysis or alteration. It is taken for granted that the HSM 3 cannot be carried (an internal memory of the HSM 3 is destroyed if the HSM 3 is attempted to be illegally taken out of the server 1). In addition, internal information of the HSM 3 cannot be copied by a third party.

In addition, in FIG. 2, reference numeral 14 denotes digital data to be an object of a digital signature prepared in the terminal for person in charge 2; 15, a digital signature requesting unit for requesting the server 1 to apply a digital signature to the digital data 14; and 16, a digital signature request reception unit that is provided in the server 1 and receives a request from the digital signature requesting unit 15 and at the same time, converts received digital data into a PDF document. Reference numeral 17 denotes a digital signature unit that is also provided in the server 1 and applies digital signature processing to the digital data received and converted into a PDF document. Note that the digital signature unit 17 adds the seal 12 to the digital data when it performs the digital signature processing. Reference numeral 18 denotes an information memory unit (digital signature recording means) that is also provided in the server 1 and stores digital data to which the digital signature processing is applied in the digital signature unit 17. In the information memory unit 18, date and time when the digital signature is applied, a person in charge (ID), a terminal for a person in charge (ID), a digital certificate, a serial number and the like are stored together with the digital data to which the digital signature processing is applied. Reference numeral 19 denotes a digital signature result transmission unit that is also provided in the server 1 and sends the digital data with a digital signature stored in the information memory unit 18 to the terminal for person in charge 2. Reference numeral 20 denotes a digital signature result receiving unit that is provided in the terminal for person in charge 2, sends a request for desired digital data with a digital signature to the digital signature result transmission unit 19 and receives pertinent digital data. The digital signature result receiving unit 20 verifies a digital signature of the received digital data. Reference numeral 21 denotes digital data with digital signature received by the digital signature result receiving unit 20 in the terminal for person in charge 2. Reference numeral 22 denotes a person in charge database memory unit which is provided in the server 1 and in which a list of persons in charge authorized to apply a digital signature (names, IDs, passwords and the like of persons in charge are included in the list) is stored. Reference numeral 23 denotes a verification program storage unit that stores a verification program for verifying effectiveness of the digital certificate 11 and verifying identification of a signer and presence or absence of falsification. The verification program storage unit 23 does not always have to be provided in the server 1 but may be provided in any place as long as it is connected to the terminal for person in charge 2 via the communication network 3 and the terminal for person in charge 2 can down load the program via the communication network 3, if necessary. Note that there maybe one or more terminals for a person in charge 2 as shown in FIG. 2.

In the above description, digital data is described as being converted into a PDF document in the digital signature request reception unit 16. However, the present invention is not limited to the above case and the digital data may be converted into a PDF document in the digital signature unit 17 or may be converted into a PDF document in a PDF documentation unit, which is provided between the digital signature request reception unit 16 and the digital signature unit 17. Moreover, the digital data may be converted not only to a PDF document but also to other structured documents such as a Word document and an Excel document.

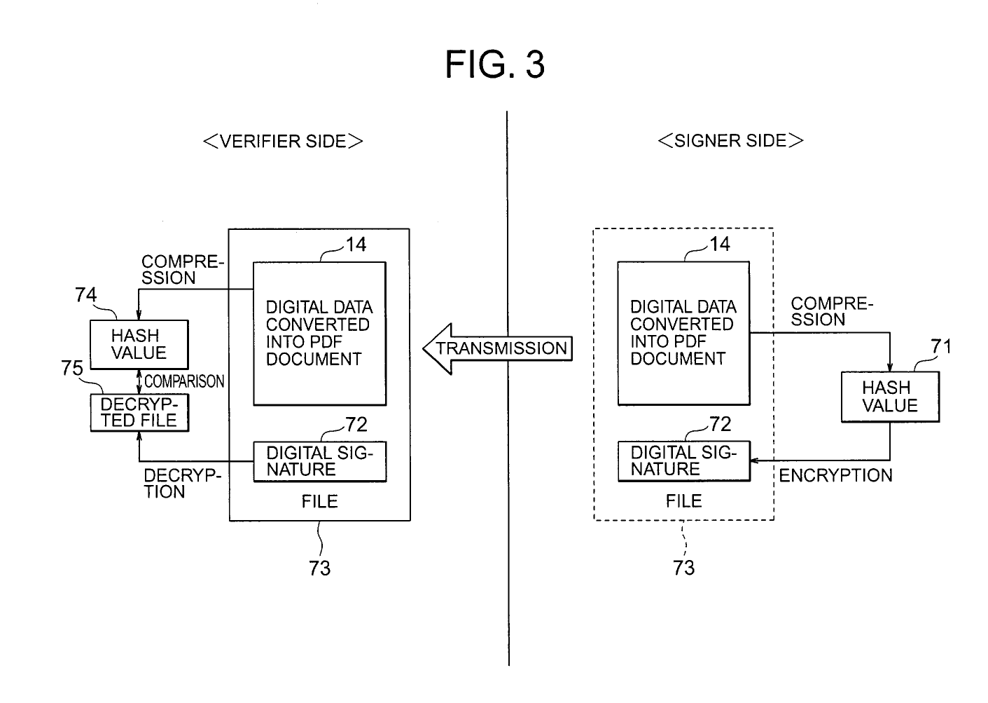

Further, as supplementation, a basic principle of the digital signature processing will be described briefly here with reference to FIG. 3. First, operations of digital signature will be described. A signer (server 1) is inputted with the digital data 14 to which the signer wishes to give a digital signature, converts the digital data 14 into a PDF document, applies compression processing to the digital data 14 converted into the PDF document using a predetermined hash function and prepares a hash value 71. Next, the signer encrypts the hash value 71 using a secret key held by the signer to generate a digital signature (also referred to as digital signature data) 72. The signer combines the original digital data 14 converted into the PDF document and the digital signature 72 into one file 73 as a document to which a signature is applied, and stores the file 73 in the information memory unit 18.

Next, operations of digital signature verification will be described. Upon receiving the file 73 in which the original digital data 14 converted into the PDF document and the digital signature 72 are combined, an authenticator (the terminal for person in charge 2) takes out the digital data 14 converted into the PDF document and applies compression processing to the digital data 14 converted into the PDF document using the hash function, which is identical to that used by the signer in the compression of the digital data 14 converted into the PDF document, to generate a hash value 74. Next, the verifier takes out the digital signature 72 and decrypts the digital signature 72 using a public key held by the verifier to generate a decrypted file 75. Next, the verifier compares the hash value 74 and the decrypted file 75. If contents of the hash value 74 and the decrypted file 75 coincide with each other, it is proved that the digital data 14 converted into the PDF document has been surely signed by the signer and has not been falsified. Note that the above-mentioned compression processings on the signer side and the verifier side do not have to be always performed. The compression processing may not be performed on any side or may be performed on both sides.

In addition, another authentication method is given as follows. In storing an original document and a digital signature, the signer stores them in the information memory unit 18 with the attachment of the digital certificate 11. Thus, the verifier may download a verification program for executing verification of the digital certificate 11 from the verification program storage unit 23 of the server 1 via the communication network 3, verify effectiveness of the digital certificate 11 and prove identification of the signer and presence or absence of falsification.

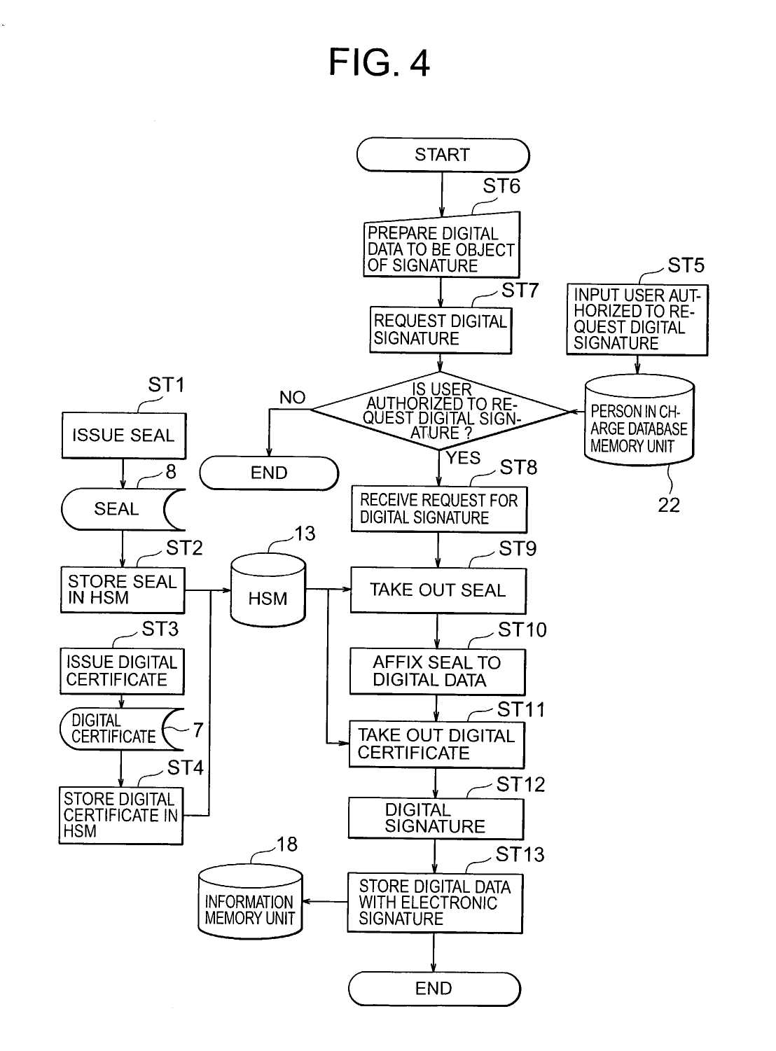

Next, processing at the time of request for digital signature will be specifically described with reference to a flow chart of FIG. 4. In step ST1, the seal 12 to be affixed to the digital data 14, which is an object of signature, at the time of digital signature is issued. In step ST2, the seal 12 issued in step ST1 is stored in the HSM 13. In step ST3, the digital certificate 11 to be used for digital signature is issued in the certification authority 10. In step ST4, the digital certificate 11 issued in step ST3 is stored in the HSM 13. In step ST5, a list of persons in charge authorized to request digital signature to the server 1 is inputted and stored in the person in charge database memory unit 22. These steps belong to a preparatory stage and are processed mainly in the server 1.

In step ST6, the digital data 14 that is an object of signature to which a digital signature is applied is prepared in the terminal for person in charge 2 or inputted from the outside. In step ST7, a request for applying a digital signature to the digital data 14 prepared in step ST6 is sent to the digital signature request reception unit 16 of the server 1 by the digital signature requesting unit 15.

In step ST8, the request for digital signature is received in the digital signature request reception unit 16 and the received digital data 14 is converted into a PDF document. In this case, it is judged whether or not a person in charge belongs to the list of persons in charge authorized to request digital signature inputted in step ST5 by searching the person in charge database memory unit 22 with an ID code, password or the like of the person in charge as a search keyword. As a result of the judgment, a digital signature request that is judged appropriate is received. Otherwise, an error message is returned to the terminal for person in charge 2 to finish the processing. Consequently, only an authorized user is capable of applying a digital signature using a digital certificate issued to an organization. In step ST9, the seal 12 that should be affixed to the received digital data at the time of digital signature is taken out of the HSM 13. In step ST10, the seal 12 taken out in step ST9 is affixed to the digital data 14. Consequently, it can be distinguished which organization has applied a digital signature even visually. In step ST11, the digital certificate 11 for applying a digital signature to the received digital data 14 is taken out of the HSM 13. In step ST12, digital signature processing is applied to the received digital data 14 using the digital certificate 11 taken out in step ST11. In step ST13, the digital data 14 to which a digital signature is applied in step ST12 is kept in the information memory unit 18 together with information on a date and a person in charge. Consequently, information on when a digital signature was applied, who applied the digital signature, and to which data the digital signature was applied can be managed. In addition, in this case, completion of digital signature and a serial number given to the digital data with a digital signature are notified to the terminal for person in charge 2 by a method using a digital mail or the like. If a person in charge wishes to refer to the digital data with a digital signature, the person in charge can take out the digital data from the information memory unit 18 of the server 1 using this serial number.

Further, in the above-mentioned description, the example is described in which the digital signature request reception unit 16 judges whether or not a person in charge is an authorized one. However, the judgment is not limited to this. When a request instruction of a digital signature is inputted in the terminal for person in charge 2 (without an operation of an operator and automatically) in step ST7, the person in charge database memory unit 22 in the server 1 may be searched using a log-in password or the like of a person in charge to judge whether or not the person in charge is authorized to request digital signature. As a result of the judgment, if the person in charge is authorized, a request for applying a digital signature is sent to the digital signature request reception unit 16 of the server 1. On the other hand, as a result of the judgment, if the person in charge is not authorized, an error message is displayed to finish the processing. Consequently, as in the above-mentioned case, it becomes possible only for the authorized users to apply a digital signature using a digital certificate issued to an organization.

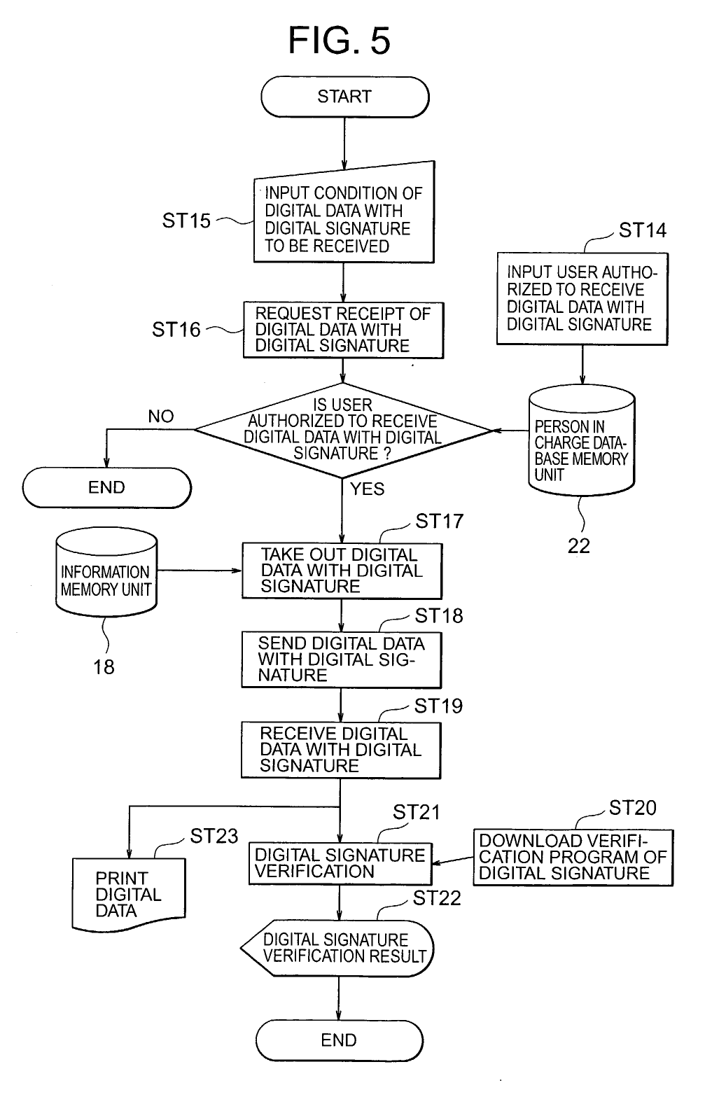

Next, processing at the time of verification of a digital signature will be described with reference to a flow chart of FIG. 5. In step ST14, user who are capable of receiving digital data with a digital signature are stored in the person in charge database memory unit 22. In step ST15, a condition of digital data with a digital signature required by the digital signature result receiving unit 20 in the terminal for person in charge 2 is inputted. The condition of digital data is the above-mentioned serial number and may include a name of a person in charge, a document name, a date and the like, if necessary. In step ST16, digital data with a digital signature is requested to the digital signature result transmission unit 19 in the server 1 based on the condition. Further, this request is received only for persons in charge inputted in step ST14 and, in the case of other persons in charge, an error message is sent to finish the processing. In step ST17, digital data with a digital signature corresponding to the request of step ST16 is retrieved and taken out of the information memory unit 18. In step ST18, the digital data with a digital signature taken out in step ST17 is sent to the digital signature result receiving unit 20 in the terminal for person in charge 2. Instep ST19, the digital data with a digital signature is received in the digital signature result receiving unit 20. In step ST20, a verification program for performing verification of the digital data with digital signature 21 received in step ST19 is downloaded from the server 1. In step ST21, verification of a digital signature is performed using the verification program downloaded in step ST20. Consequently, verification of a digital signature can be performed easily. In step ST22, a result of the verification of a digital signature performed in step ST21 is displayed. In step ST23, the digital data with digital signature 21 is printed. Since the seal 12 is affixed to the digital data, an organization that issued the digital data can be visually recognized.

As described above, in this embodiment, since the digital certificate 11 issued to an organization is unitarily managed on a server while ensuring security, strict management becomes possible and a theft and illegal use can be prevented.

In addition, since the digital certificate 11 is stored in the HSM 13 with tamper resistance, a theft and illegal copy by a third party can be prevented.

In addition, since the digital signature processing is performed on a server, management of digital data with a digital signature and management of an execution record of a digital signature, and the like, can be performed more surely compared with the conventional digital signature system in which the digital signature processing is performed by individual operator terminals.

In addition, since a list of persons in charge authorized to request a digital signature from a server is stored in the person in charge database memory unit 22 in advance, only the authorized persons in charge can request a digital signature from the server, and requests for the digital signature from the other persons in charge are not received by the server. Thus, it can be guaranteed that a person who belongs to an organization of the persons in charge and is an authorized person in charge has applied a digital signature.

Further, since all digital data to which a digital signature has been applied is stored in the information memory unit 18 and a date and time when the digital signature was applied and a name of a person in charge who applied the digital signature are also stored, all information on when a digital signature was applied, who applied the digital signature, and to what kind of document the digital signature was applied can be managed.

Moreover, since a seal is affixed to digital data when the digital signature processing is performed, it can be distinguished visually which organization issued the digital data by printing the digital data as in the case of a conventional paper medium.

Second Embodiment

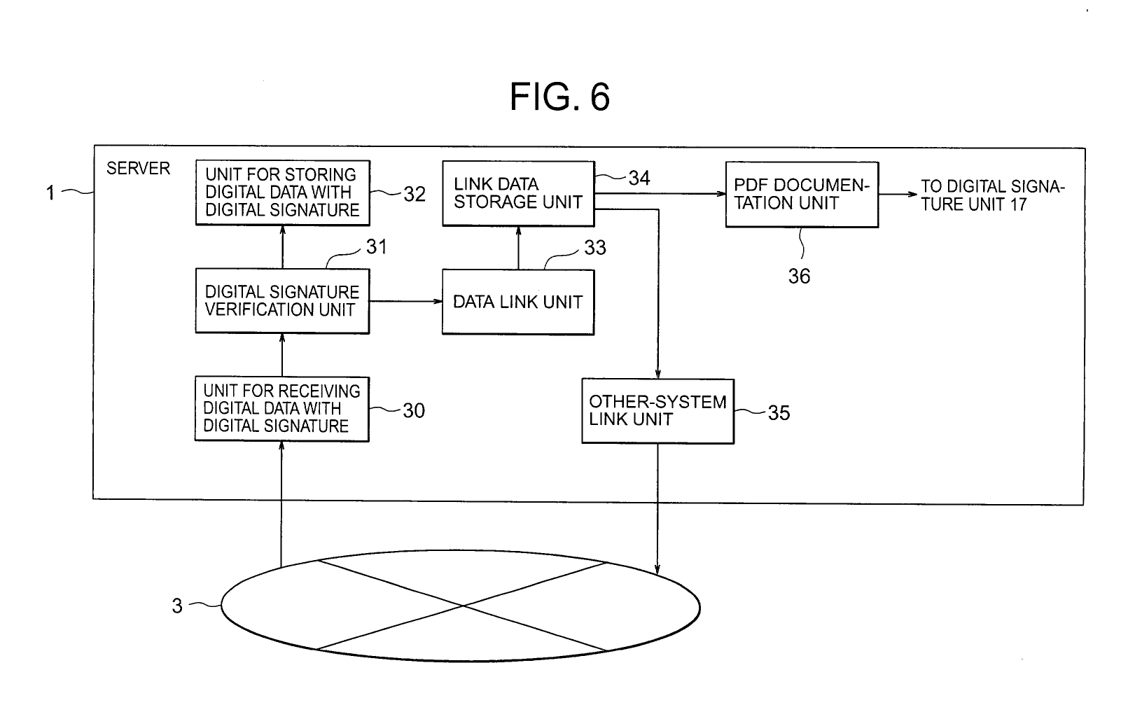

In this embodiment, optional functions that can be added to the server 1 of the first embodiment shown in FIG. 2 will be described. FIG. 6 shows only optional functions of the server 1. In this embodiment, it is taken for granted that the components denoted by reference numerals 13, 16, 17, 18, 19, 22 and 23 in FIG. 2 are provided in the server 1.

In FIG. 6, reference numeral 30 denotes a unit for receiving digital data with digital signature that receives digital data with a digital signature inputted from the outside via the communication network 3, and 31 denotes a digital signature verification unit for verifying a digital signature of the received digital data with a digital signature. Note that it is assumed that the verification is performed using the verification program in the verification program storage unit 23. Reference numeral 32 denotes a unit for storing digital data with a digital signature that stores digital data for which a digital signature has been verified.

In addition, in FIG. 6, reference numeral 33 denotes a data link unit for taking out necessary data from the digital data verified by the digital signature verification unit 31. The data taken out by the data link unit 33 is converted into CSV, XML or the like, if necessary, and used for other processing in the server 1 or other systems. Reference numeral 34 denotes a link data storage unit in which the data taken out by the data link unit 33 is stored. Reference numeral 35 denotes an other-system link unit for sending the data stored in the link data storage unit 34 to other systems. Reference numeral 36 denotes a PDF documentation unit for converting the data stored in the link data storage unit 34 into a PDF document. The data converted into a PDF document by the PDF documentation unit 36 can be sent to the above-mentioned digital signature unit 17 and subjected to digital signature processing.

Convenience is further improved by providing the optional functions shown in this embodiment in the server 1.

The present invention provides the digital signature system including: at least one terminal device for operation by users connected to a communication network; and a server connected to the communication network, in which the server includes: digital certificate storing means for storing a digital certificate to be shared by the users; digital signature processing means for applying digital signature processing to digital data that is an object of digital signature using the digital certificate; user database storing means for storing a database of a user authorized to request a digital signature to the digital signature processing means; digital signature request reception means for receiving a request for digital signature that is sent from the terminal device together with the digital data that is an object of digital signature; and judging means for judging whether or not the received request for digital signature is one sent by the user stored in the user database storing means, and in which the digital signature processing means performs the digital signature processing based on the request for digital signature that is judged to be appropriate by the judging means. Thus, it is also possible to prevent, for example, a theft and illegal use for a digital certificate issued to an organization like an official seal and guarantee that the digital data is one to which a digital signature has been applied in the capacity of the organization.

What is claimed is:

1. A digital signature system comprising:
at least one terminal device for operation by users connected to a communication network; and
a server connected to the communication network,
wherein the server comprises:
digital certificate storing means for storing a digital certificate to be shared by the users;
digital signature processing means for applying digital signature processing to digital data that is an object of digital signature using the digital certificate;
user database storing means for storing a database of a user authorized to request a digital signature to the digital signature processing means;
digital signature request reception means for receiving a request for digital signature that is sent from the terminal device together with the digital data that is an object of digital signature; and
judging means for judging whether or not the received request for digital signature is one sent by the user stored in the user database storing means, and
wherein the digital signature processing means performs the digital signature processing based on the request for digital signature that is judged to be appropriate by the judging means.

2. A digital signature system according to claim 1,
wherein the digital certificate storing means is tamper resistant.

3. A digital signature system according to claim 1 or 2,
wherein the digital signature processing means adds seal data to the digital data that is an object of digital signature when the digital signature processing is performed, and the seal data is stored in the digital certificate storing means together with the digital certificate.

4. A digital signature system according to any one of claims 1 to 3,
wherein the server further comprises digital signature recording means for storing the digital data to which the digital signature processing means applies digital signature processing.

5. A digital signature system according to claim 4,
wherein the server further comprises digital signature result transmission means for taking out digital data designated by the terminal device from the digital signature recording means so as to send to the terminal device.

6. A digital signature system according to any one of claims 1 to 5,
wherein the terminal device comprises verification means for verifying a digital signature of the digital data sent by the digital signature result transmission means.

7. A digital signature system according to claim 6,
wherein the server further comprises verification program storing means storing therein a verification program for performing verification by the verification means.
